(19) United States
(12) Patent Application Publication
(10) Pub. No.: US 2014/0129586 A1
(43) Pub. Date: May 8, 2014

(54) MANAGING INTERNET SEARCHES BASED ON DATABASE QUERY RESULTS

(71) Applicant: INTERNATIONAL BUSINESS MACHINES CORPORATION, Armonk, NY (US)

(72) Inventors: Barry Alan KRITT, Raleigh, NC (US); Sarbajit K. RAKSHIT, Kolkata (IN)

(73) Assignee: INTERNATIONAL BUSINESS MACHINES CORPORATION, Armonk, NY (US)

(21) Appl. No.: 13/668,704

(22) Filed: Nov. 5, 2012

(51) Int. Cl. G06F 17/30

(52) U.S. Cl. 707/769; 707/E17.014

(57) ABSTRACT

Embodiments of the present invention manage information searches based on database query results. In one embodiment, a set of database query results including a set of data items is received. At least one information search term is received from a user. An information search query is generated based on the set of database query results and the at least one information search term. A search is performed on a set of information based on the information search query. A set of search results including a set of information satisfying the information search query is received based on performing the search.

### BACKGROUND

The present invention generally relates to information searches, and more particularly relates managing and performing information searches based on database query results.

Performing manual searches for information across a large network can be a very difficult, if not an impossible task. This is mostly due to vast amount of information currently being stored across networks. Therefore, information searches are generally performed using one or more searching tools that can search large amounts of information across various networks. One example of a searching tool is an Internet search engine. In general, search engines are programs that search a network such as the Internet or local intranets for specified keywords and return a list of links to web-pages or files where the keywords are found. Search engines allow for a large amount of information to be searched more efficiently as compared to performing manual searches.

### BRIEF SUMMARY

In one embodiment, a method for managing information searches based on database query results is disclosed. The method comprises receiving a set of database query results comprising a set of data items is received. At least one information search term is received from a user. An information search query is generated based on the set of database query results and the at least one information search term. A search is performed on a set of information based on the information search query. A set of search results comprising a set of information satisfying the information search query is received based on performing the search.

In another embodiment, an information processing system for managing information searches based on database query results is disclosed. The information processing system comprises a memory and a processor that is communicatively coupled to the memory. A search manager is communicatively coupled to the processor and the memory, and is configured to perform a method. The method comprises receiving a set of database query results comprising a set of data items is received. At least one information search term is received from a user. An information search query is generated based on the set of database query results and the at least one information search term. A search is performed on a set of information based on the information search query. A set of search results comprising a set of information satisfying the information search query is received based on performing the search.

In yet another embodiment, a computer program product for managing information searches based on database query results is disclosed. The computer program product comprises a storage medium readable by a processing circuit and storing instructions for execution by the processing circuit for performing a method. The method comprises receiving a set of database query results comprising a set of data items is received. At least one information search term is received from a user. An information search query is generated based on the set of database query results and the at least one information search term. A search is performed on a set of information based on the information search query. A set of search results comprising a set of information satisfying the information search query is received based on performing the search.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates one example of an interactive environment for entering information search queries and database query information for performing an information search according to one embodiment of the present invention;

FIG. 3 illustrates the interactive environment of FIG. 2 where various database/report server objects have been displayed for selection by a user according to one embodiment of the present invention;

FIG. 4 illustrates the interactive environment of FIG. 2 where a user has selected one or more of the database/report server objects of FIG. 3 for generating a database query according to one embodiment of the present invention;

FIG. 5 illustrates a search results page of the interactive active environment of FIG. 2 displaying information search results associated with a first database query result item according to one embodiment of the present invention;

FIG. 6 illustrates a search results page displaying information search results associated with a second database query result item according to one embodiment of the present invention;

FIG. 7 is an operational flow diagram illustrating one example of managing an information search query based on database query results according to one embodiment of the present invention; and

FIG. 8 is a block diagram illustrating a detailed view of an information processing system according to one embodiment of the present invention.

### DETAILED DESCRIPTION

Operating Environment

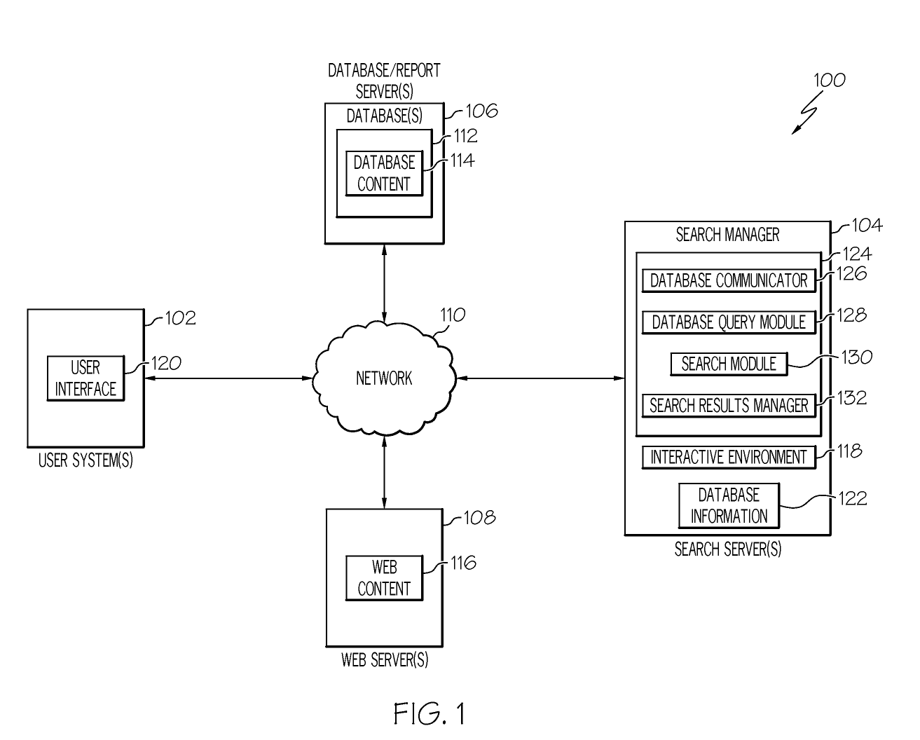

FIG. 1 illustrates one example of an operating environment for managing and performing information searches based on database query results. In particular, FIG. 1 shows a plurality of information processing systems 102, 104, 106, 108 communicatively coupled to one or more networks 110. For example, one or more user systems 102, search servers 104, database/report servers 106, and web servers 108 are communicatively coupled to the network(s) 110. The database server 106 comprises one or more databases 112 and corresponding database content 114, which can be any data (and attributes) capable of being maintained and organized by a database 106. The web server 108 comprises web content 116 such as, but not limited to, websites and their web pages.

The search server 104 provides an interactive environment 118 for users of the user system 102. Users access/interact with this environment 118 via a user interface 120 or programmatically via an application programming interface(s) (API). Examples of a user interface 120 are a web browser, an application, etc. The interactive environment 118, in one embodiment, is a web page, application, service, etc., that allows a search for information such as web content 116 based on database queries performed on the database content 114. The interactive environment 118 is discussed in greater detail below.

In one embodiment, the search server 104 comprises database information 122 for establishing a connection with one or more databases 112 (or least the database server 106). The database information 122 also comprises information for establishing a connection with one or more database report servers. A database report server can be the same as the database server 106 or a separate server (not shown) communicatively coupled to the database server 106. The search server 104 further comprises a search manager 124. The search manager 124 comprises a database communicator 126, a database query module 128, a search module 130, and a search results manager 132. The search manager 124 and its components are discussed in greater detail below. It should be noted that one or more components of the search server 124 can reside within the user system 102, database server 106, and/or web server 108 as well.

Managing Information Searches Based on Database Query Results

The following is a more detailed discussion on managing and performing information searches based on database query results. It should be noted that even though the following discussion uses Internet searches as one example of an information search, embodiments of the present invention are not limited to this example. For example, searches for information on local networks, virtual private networks, intranets, etc. are also applicable as well.

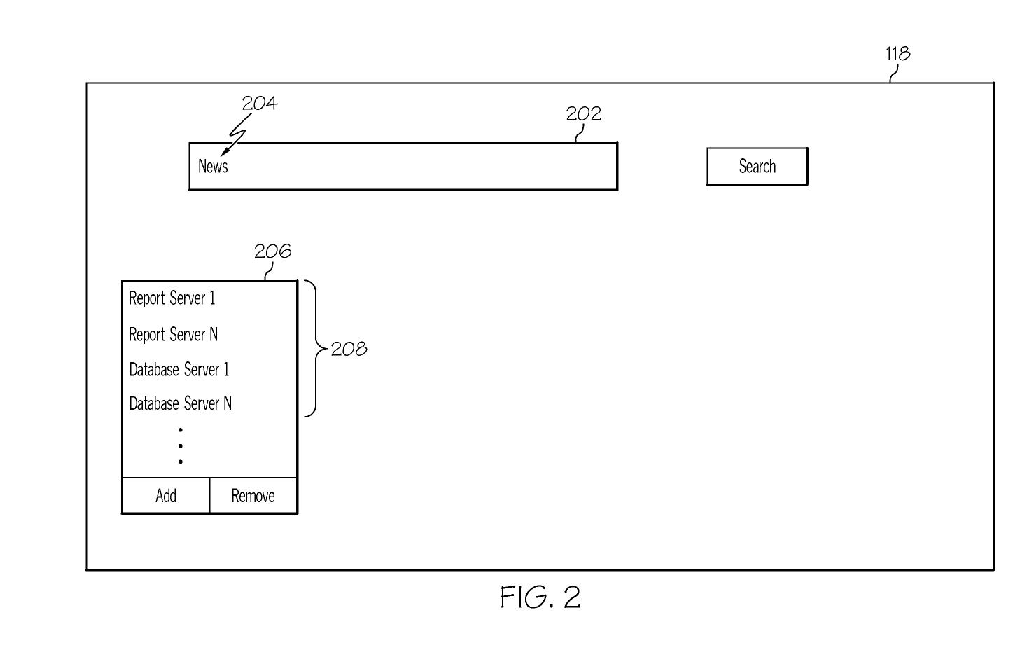

FIG. 2 shows one example of the interactive environment 118 provided by the search server 122. In this example, a first portion 202 of the interactive environment 118 allows a user to enter information search terms/keywords 204. A second portion 206 of the interactive environment 118 presents a list 208 of database and/or report servers for performing a query thereon. It should be noted that if a database/report server is associated with multiple databases each of these multiple databases, in one embodiment, are also included within the list 208. The user is able then able to select the individual databases of interest. The user can also add or remove database/report servers (and individual databases) to/from the list 208 as well.

In one embodiment, the list 208 of database/report servers is populated based on the database information 122 maintained by the search manager 124. The database information 122, in one embodiment, comprises one or more identifiers associated with the database/report servers 106 (and optionally individual databases 112 at the servers) that are associated with the search manager 124 and/or the given user. For example, the search manager 124 can be authorized to query one or more given database/report servers 106 and/or individual databases 112. Also, various users can also be associated with different database/report servers 106 and/or individual databases 112. Therefore, the search manager 124 populates the database/report server list 208 based on the database/report servers 106 and/or individual databases 112 for which the search manager 124 and/or the user is authorized to access.

The database information 122 also comprises location information such as (but not limited to) an Internet Protocol (IP) address associated with each database/report server. The database information 122 further includes any connection and authentication information needed by the search manager 124 to establish a connection and communicate with each of the database/report servers 106 (and their individual databases 112). For example, the connection and authentication information can include communication and authentication protocols. In addition, the connection and authentication information can include user authentication information (e.g., user identifier (ID) and password) provided by the user for accessing a given database/report server 106 (and their individual databases 112). This user authentication information is used by the search manager 124 to access the database/report server on behalf of the user and/or to verify if the user is authorized to view information from the database/report servers 106 (and their individual databases 112).

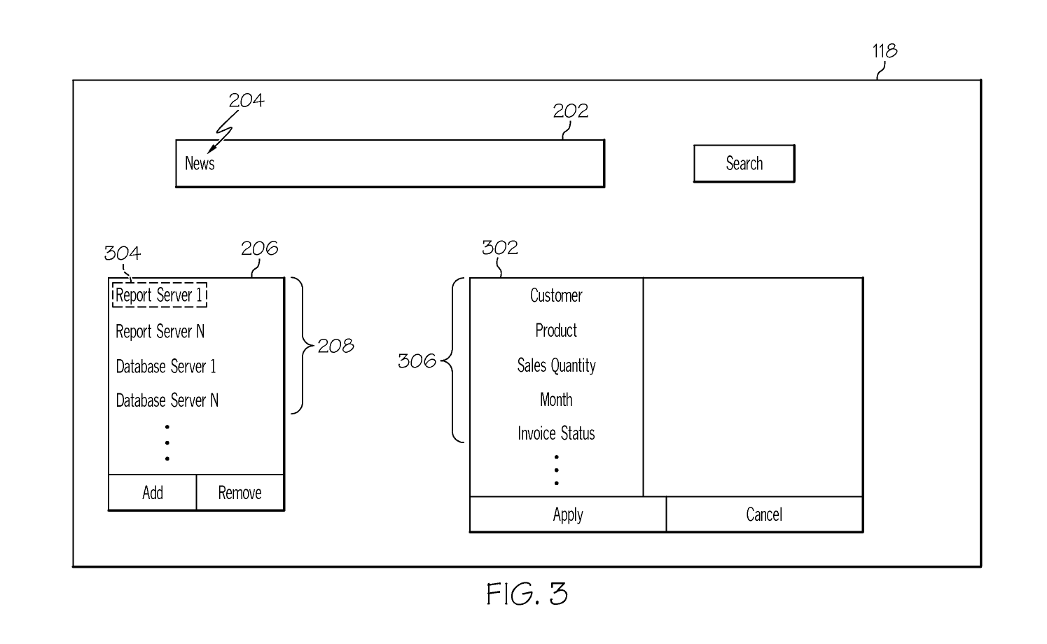

The search manager 124 also provides a query section 302 in the interactive environment 118, as shown in FIG. 3. In one embodiment, the query section 302 is an API that interfaces with the selected database/report servers 106 (and individual databases 112 if selected). For example, FIG. 3 shows that the user has selected “Report Server 1” as indicated by the dashed box 304. Therefore, the database communicator 126 of the search manager 124 establishes a connection with “Report Server 1” (and any other selected database/report servers and/or individual databases) using the connection and authentication data within the database information 122.

The database communicator 126 uses this connection to obtain the database objects (e.g., table/column, views, etc.) and/or report server objects (e.g., dimensions, measures, etc.) from the selected database/report server(s) 106 (and/or database(s) 112). The search manager 124 then presents these objects 306 to the user in the interactive environment 118, as shown in FIG. 3. For example, FIG. 3 shows the following data objects 306 associated with Report Server 1 selected by the user: Customer, Product, Sales Quantity, Month, and Invoice Status.

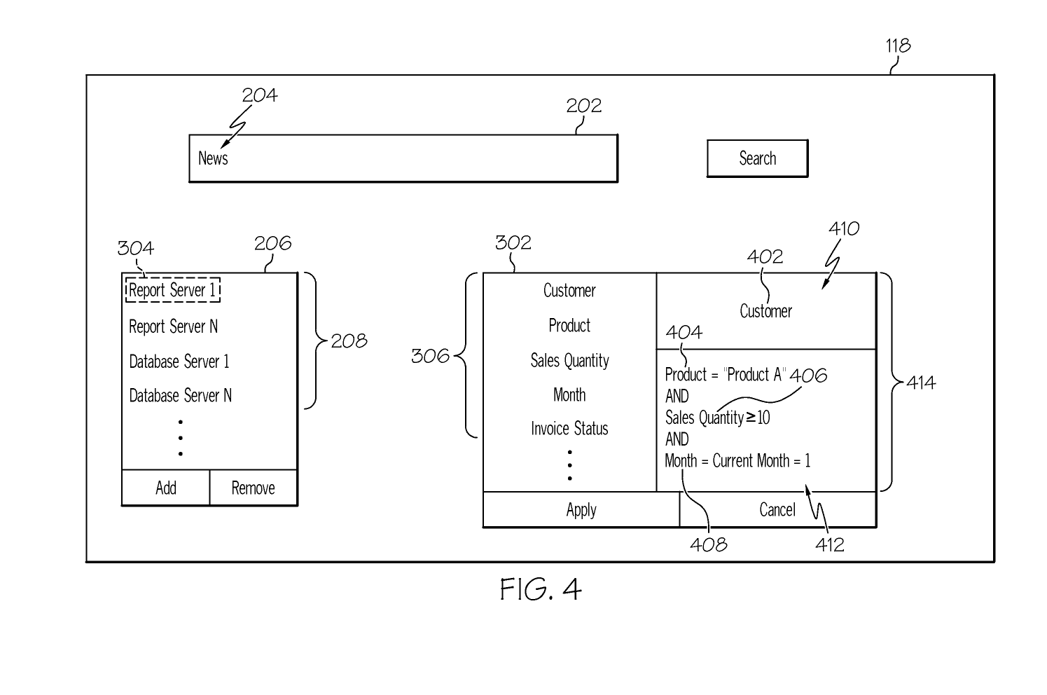

The user is able to select one or more of these objects 306 to create a database/report query. In current example, the user wants to create a query to identify all customers that have purchased a given number of units for a given product within a given period of time. Therefore, the user selects the “Customer” 402, “Product” 404, “Sales Quantity” 406, and “Month” 408 objects from the object list 306, and places these objects into a “select” area 410 and/or a “filter” area 412 of the query section 302, as shown in FIG. 4. For example, FIG. 4 shows that the user has selected the “Customer” object 402 and has added it to the “select” area 410. The “select” area 410 corresponds to a “select” statement and receives a user's input identifying the data to retrieve from a database. FIG. 4 also shows that the user has placed the “Product” 404, “Sales Quantity” 406, and “Month” 408 in to the “filter” area 412. The “filter” area 412 corresponds to a “where” clause of a “select” statement. It should be noted that additional areas can be provided within the interactive environment 118 corresponding to GROUP BY, HAVING, and ORDER BY clauses of a select statement. It should also be noted that the user can optional write his/her own query statement within the interactive environment 118 instead of (or in addition to) manually selecting one or more objects from the object list 306.

Once query information 414 (e.g., the information within the “select” and “filter” areas 410, 412) interactive environment 118 has been added into the query section 302 by the user, the user can initiate the information search by submitting the information search terms/keywords 204 and the query information 416 to the search manager 124. The search manager 124 generates a database query to be performed on the selected database/report server (e.g., Report Server 1) based on the query information 416 received from the user. For example, in the current example the database query module 128 of the search manager 124 generates a query such as SELECT Customer FROM Report_Server_{—}1 WHERE Product=Product_A AND WHERE Sales_Quantity≧10 AND WHERE Month=Current_Month-1. It should be noted that if the user has submitted an actual query statement the search manager 124 is not required to generate a query, and utilizes the statement submitted by the user. The database query module 128 of the search manager 124 then utilizes the generated (or user provided) query statement to perform one or more queries on the database content 114. A set of database/report query results is then returned to the search manager 124. For example, based on the query in the current example, a set of query results comprising “Customer 1, Customer 2, . . . , Customer N” is returned.

The search manager 124 utilizes the set of database query results and the information search terms/keywords 204 to generate one or more information search queries. For example, in the current example, the search manager 124 generates an information search query comprising the entire set of database query results (e.g., “Customer 1, Customer 2, . . . , Customer N”) and the information search keyword of “News”. In another example, the search manager 124 generates multiple information search queries for one or more result items in the database query results. For example, the search manager 124 generates a first information search query comprising the database query result of “Customer 1” and “News”; a second information search query comprising the database query result of “Customer 2” and “News”, etc. In these examples, the search module 130 of the search manager 124 performs an individual information search for web content 116 at web servers 108 that satisfies the search conditions of “Customer 1” AND “News”, “Customer 2” AND “News”, etc.

For example, the search module 130 can search for web content 116 such as text, video, and/or audio that includes the search query conditions (e.g., “Customer 1” and “News”). The search module 130 can also search for web content 116 that includes one or more of the query conditions and is of a type identified by one or more of the other query conditions. For example, the search module 130 can identify web content 116 that is of a “News” type and comprises “Customer 1”. Once the search module 130 has performed the information searches based on the generated information search queries, one or more sets of information search results are received.

The search results manager 132, in one embodiment, provides all of the information search results to the user for each information search query to the user. For example, if multiple search queries were performed (e.g., one for each database query result item), the entire set of search results can be aggregated together provided to the user. The results can be organized (e.g., re-ranked) based on the database query results. For example, the database query results are associated with a given grouping order, sort order, etc. such as “Customer 1, Customer 2, . . . , Customer N”. Therefore, the information search results associated with “Customer 1” are grouped together and displayed first, while the information search results associated with “Customer 2” are grouped together and displayed after the information search results associated with “Customer 1”, etc.

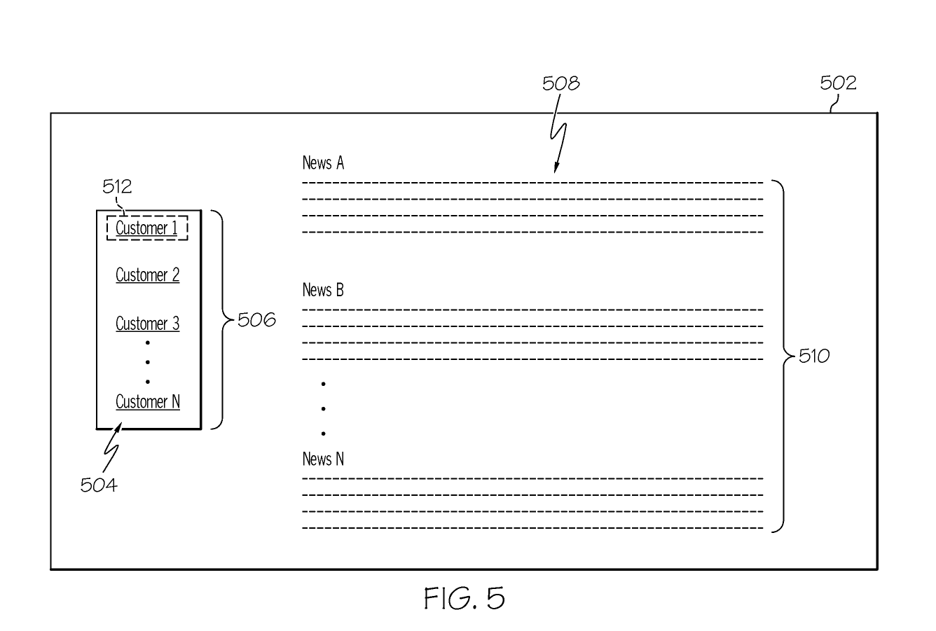

In another embodiment, the search results manager 132 displays each of the database query results within a search results page 502 of the interactive environment 118 along with their information search results, as shown in FIG. 5. For example, FIG. 5 shows that a first portion 504 of the search results page 502 presents each item/entry in the database query results 506. In this embodiment, the items/entries of the database query results 506 are displayed based on the sorting/grouping associated therewith. The sorting/grouping can be a default sorting/grouping or can be a specific sporting/grouping provided by the user in the query section 302 of FIG. 3.

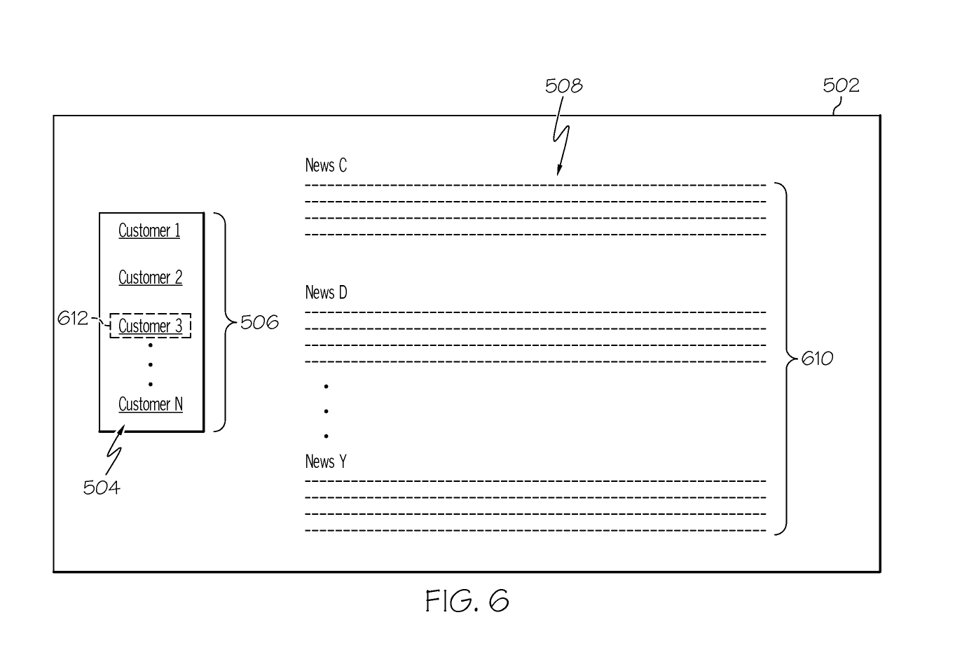

FIG. 5 also shows that a second portion 508 of the search results page 502 displays the information search results 510 associated with the currently selected 512 or default (e.g., the first displayed database query result item) to the user. The user is able to select another item/entry 612 from the displayed database query result 506 to view the information search results 610 associated therewith, as shown in FIG. 6. For example, FIG. 6 shows that the user has selected “Customer 3” as indicated by the dashed box 612. FIG. 6 also shows that the search manager 124 has updated the search results page 502 to provide the user with the information search results 610 associated with “Customer 3”.

As can be seen from the above discussion, one or more embodiments perform information searches based on database query results. This allows users to identify and obtain web content associated with their database information in an easy and efficient manner. For example, a user can enter information search keywords/terms and database query information in a single interface. One or more embodiments of the present invention perform a database query based on the information provided by the use. An information search query is generated based on the database query results and any information search keywords provided by the user. An information search is then performed using the generated information search query. Information search results are obtained for one or more of the database query result items. These information search results can then be sorted/grouped (e.g., re-ranked) based on the database query results.

Operational Flow Diagram

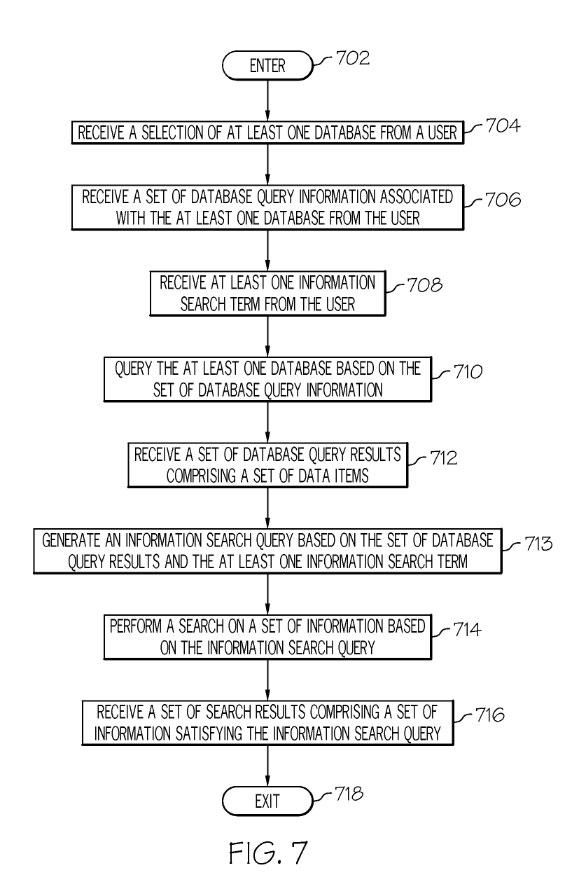

FIG. 7 is an operational flow diagram illustrating one example of managing information searches based on database query results. The operational flow diagram of FIG. 7 begins at step 702 and flows directly to step 704. The search manager 124, at step 704, receives a selection of at least one database from a user. The search manager 124, at step 706, receives a set of database query information associated with the at least one database from the user. The set of database query information comprises at least one query term. The search manager 124, at step 708, receives at least one information search term from the user. The search manager 124, at step 710, queries the at least one database based on the set of database query information.

The search manager 124, at step 712, receives a set of database query results comprising a set of data items. The search manager 124, at step 713, generates an information search query based on the set of database query results and the at least one information search term. The search manager 124, at step 714, performs a search on a set of information based on the information search query. The search manager 124, at step 716, receives a set of search results comprising a set of information satisfying the information search query. The control flow then exits at step 718.

Information Processing System

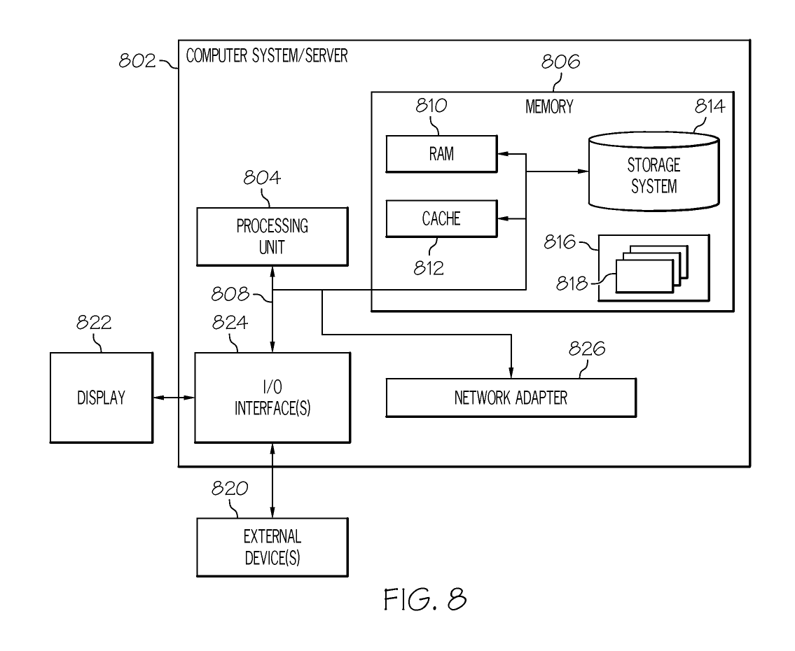

FIG. 8 illustrates one example of an information processing system that can be utilized in embodiments of the present invention. The information processing system 802 is based upon a suitably configured processing system configured to implement one or more embodiments of the present invention (e.g., the information processing system 102 of FIG. 1). Any suitably configured processing system can be used as the information processing system 802 in embodiments of the present invention. The components of the information processing system 802 can include, but are not limited to, one or more processors or processing units 804, a system memory 806, and a bus 808 that couples various system components including the system memory 806 to the processor 804.

The bus 808 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 8, the main memory 806 includes the search manager 124 and its components, and the database information 122. The search manager 124 (and its components) can also reside within the processor 804, or be a separate hardware component. The system memory 806 can also include computer system readable media in the form of volatile memory, such as random access memory (RAM) 810 and/or cache memory 812. The information processing system 802 can further include other removable/non-removable, volatile/non-volatile computer system storage media. By way of example only, a storage system 814 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 808 by one or more data media interfaces. The memory 806 can include at least one program product having a set of program modules that are configured to carry out the functions of an embodiment of the present invention.

Program/utility 816, having a set of program modules 818, may be stored in memory 806 by way of example, and not limitation, as well as an operating system, one or more application programs (e.g., applications 108), other program modules, and program data. Each of the operating system, one or more application programs, other program modules, and program data or some combination thereof, may include an implementation of a networking environment. Program modules 818 generally carry out the functions and/or methodologies of embodiments of the present invention.

The information processing system 802 can also communicate with one or more external devices 820 such as a keyboard, a pointing device, a display 822, etc.; one or more devices that enable a user to interact with the information processing system 802; and/or any devices (e.g., network card, modem, etc.) that enable computer system/server 802 to communicate with one or more other computing devices. Such communication can occur via I/O interfaces 824. Still yet, the information processing system 802 can communicate with one or more networks such as a local area network (LAN), a general wide area network (WAN), and/or a public network (e.g., the Internet) via network adapter 826. As depicted, the network adapter 826 communicates with the other components of information processing system 802 via the bus 808. Other hardware and/or software components can also be used in conjunction with the information processing system 802. Examples include, but are not limited to: microcode, device drivers, redundant processing units, external disk drive arrays, RAID systems, tape drives, and data archival storage systems.

Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing information searches based on database query results, the method comprising:
receiving a set of database query results comprising a set of data items;
receiving, from a user, at least one information search term;
generating an information search query based on the set of database query results and the at least one information search term;
performing a search on a set of information based on the information search query; and
receiving a set of search results comprising a set of information satisfying the information search query.

2. The method of claim 1, further comprising:
providing the set of search results to the user.

3. The method of claim 1, wherein receiving the set of database query results is based on:
receiving, from the user, a selection of at least one database;
receiving, from the user, a set of database query information associated with the at least one database, wherein the set of database query information comprises at least one query term; and
querying the at least one database based on the set of database query information.

4. The method of claim 1, wherein the generating comprises:
aggregating at least one of the set of data items with the at least one information search term.

5. The method of claim 1, further comprising:
sorting the set of search results based on the set of data items within the set of database query results.

6. The method of claim 1, further comprising:
grouping the set of search results into a plurality of groups based on the set of data items within the set of database query results.

7. The method of claim 6, wherein each of the plurality of groups corresponds to one of the set of data items.

8. The method of claim 7, further comprising:
providing a first group of search results associated with a first data item to the user.

9. The method of claim 7, further comprising:
receiving, from the user, a selection of a second data item; and
providing a second group of search results associated with the second data item to the user.

10. An information processing system for managing information searches based on database query results, the information processing system comprising:
a memory;
a processor communicatively coupled to the memory; and
a search manager communicatively coupled to the memory and the processor, wherein the search manager is configured to perform a method comprising:
receiving a set of database query results comprising a set of data items;
receiving, from a user, at least one information search term;
generating an information search query based on the set of database query results and the at least one information search term;
performing a search on a set of information based on the information search query; and
receiving a set of search results comprising a set of information satisfying the information search query.

11. The information processing system of claim 10, wherein receiving the set of database query results is based on:
receiving, from the user, a selection of at least one database;
receiving, from the user, a set of database query information associated with the at least one database, wherein the set of database query information comprises at least one query term; and
querying the at least one database based on the set of database query information.

12. The information processing system of claim 10, wherein the method further comprises:
grouping the set of search results into a plurality of groups based on the set of data items within the set of database query results, wherein each of the plurality of groups corresponds to one of the set of data items.

13. The information processing system of claim 12, wherein the method further comprises:
providing a first group of search results associated with a first data item to the user.

14. The information processing system of claim 13, wherein the method further comprises:
receiving, from the user, a selection of a second data item; and
providing a second group of search results associated with the second data item to the user.

15. A computer program storage product for managing information searches based on database query results, the computer program storage product comprising instructions configured to perform a method comprising:
receiving a set of database query results comprising a set of data items;
receiving, from a user, at least one information search term;
generating an information search query based on the set of database query results and the at least one information search term;
performing a search on a set of information based on the information search query; and
receiving a set of search results comprising a set of information satisfying the information search query.

16. The computer program storage product of claim 15, wherein receiving the set of database query results is based on:
receiving, from the user, a selection of at least one database;
receiving, from the user, a set of database query information associated with the at least one database, wherein the set of database query information comprises at least one query term; and
querying the at least one database based on the set of database query information.

17. The computer program storage product of claim 15, wherein the method comprises at least one of:
sorting the set of search results based on the set of data items within the set of database query results; and
grouping the set of search results into a plurality of groups based on the set of data items within the set of database query results.

18. The computer program storage product of claim 17, wherein each of the plurality of groups corresponds to one of the set of data items.

19. The computer program storage product of claim 18, wherein the method further comprises:
providing a first group of search results associated with a first data item to the user.

20. The computer program storage product of claim 19, wherein the method further comprises:
receiving, from the user, a selection of a second data item; and
providing a second group of search results associated with the second data item to the user.
